(19) United States
(12) Patent Application Publication
(10) Pub. No.: US 2018/0093874 A1
(43) Pub. Date: Apr. 5, 2018

(54) APPARATUS FOR FILLING AND CLOSING CONTAINERS

(71) Applicant: KHS Corpoplast GmbH, Hamburg (DE)

(72) Inventors: Michael LINKE, Hamburg (DE); Michael LITZENBERG, Geesthacht (DE); Niels MEYER, Schenefeld (DE)

(21) Appl. No.: 15/553,161

(22) PCT Filed: May 2, 2016
(86) PCT No.: PCT/EP2016/000708

§ 371 Date: Aug. 23, 2017

(30) Foreign Application Priority Data
Apr. 30, 2015 (DE) 10 2015 005 458.9

(51) Int. Cl. B67C 7/00; B67C 3/00

(52) U.S. Cl. CPC B67C 7/0053; B65B 3/022; B67C 3/005

(57) ABSTRACT

The present invention relates to an apparatus for filling and closing containers. The problem of the present invention is to develop an apparatus for filling and closing containers such that the risk of the apparatus being contaminated by spilled contents is effectively prevented. This problem is solved by an apparatus for filling and closing containers which comprises a first process wheel (1) for filling a container and a second process wheel (2) for closing a filled container and also a transfer device (3) for transferring the filled containers from the first process wheel (1) to the second process wheel (2). The transfer device (3) has a linear transfer route (4).

The present invention concerns an apparatus for filling and closing containers.

Traditionally, containers, especially bottles, are formed in the blow molding process by a forming gas flowing under pressure into a preheated preform and filled in a later step with a filling material, especially a liquid filling material. For a more efficient production, in recent time methods have been developed in which the preheated preform can be formed and filled in one step, not by a pressurized gas, but by the liquid filling material supplied under pressure. One such method is known, e.g., from DE 10 2010 007 541 A1.

Preforms for the known methods consist of a thermoplastic plastic, such as PET, PE or PP, and they are usually produced in the injection molding process. For the shaping into containers it does not matter whether the preforms are previously stockpiled or taken directly to the shaping process after being produced.

In order for a preform to be shaped into a container, it is thermally processed, i.e., heated in particular and provided with a suitable temperature profile. The body of the preform is heated for example to around 120° C. and can be shaped, while the mouth region should only reach significantly lower temperatures, as the preform is held at its mouth region in the forming and filling machine and should not become deformed under the usual holding forces there. For the thermal processing, an apparatus for the production of filled containers has a heating section, along which the preforms are taken and given the desired temperature profile.

The preforms or formed containers are moved on transport wheels through the machine, which have holders for preforms or containers. There are process wheels which are combined, for example, with the forming and filling stations or the closing stations of the machine, and on which the preform is formed and filled or closed, or pure transport wheels on which the preform or the container is transported from one station to the next.

During the transfer between the wheels, on account of the reversal of the direction of turning there are large accelerations of the preform or container being transferred from one wheel to another. Significant forces occur, which act on the holding elements and may cause an imbalance in the machine, especially if the containers are already filled. Furthermore, there is the risk that liquid filling material will spill from the container as long as the container is not yet closed, i.e., especially during the transfer between the filling and the closing station.

The problem of the present invention is to modify an apparatus for the filling and closing of container so that the risk of the apparatus becoming contaminated with spilled filling material is effectively prevented.

This problem is solved by an apparatus for filling and closing cContainers which comprises a first process wheel for filling a container and a second process wheel for closing a filled container and also a transfer device for transferring the filled containers from the first process wheel to the second process wheel. The apparatus according to the invention is characterized in that the transfer device has a linear transfer line.

The apparatus according to the invention comprises at least one process wheel for filling containers and an additional process wheel for closing the filled containers. Of course, the apparatus may comprise further components, such as feeding mechanisms for the feeding of empty containers or blanks for containers and removal mechanisms for the removal of the filled and closed containers or labeling devices.

The filling device may also be a device for the simultaneous forming and filling of containers made from preforms by filling material introduced into the respective preform under high pressure. In this case, the device may furthermore advantageously comprise a heating device for the thermal processing of the preforms. Other additional components of the apparatus are conceivable without leaving the scope of protection of this application.

Thanks to the linear transfer line of the transfer device, the containers filled in the filling station are transported along a linear line to the closing station. At the exit from the first process wheel for the filling of the container there is no reversal of the direction of turning, such as is the case with the machines used heretofore. No countervailing accelerations act on the filled container during the transfer in the transfer device. There is no danger of filling material being spilled, contaminating the apparatus and changing the previously filled volume of filling material.

Advisedly, the linear transfer line of the transfer device is arranged tangentially to the circumference of the first process wheel and/or to the circumference of the second process wheel. In this way, the transfer of the filled, unclosed containers from the filling station to the transfer device and/or from the transfer device to the closing device can occur in gentle manner, especially without a reversal of the direction of turning and thus the associated acceleration. The risk of spilled filling material is significantly reduced.

Advisedly, the first and the second process wheel as well as the transfer device may be arranged inside a wet area closed off from the other components of the apparatus. During the filling of liquid filling materials there is always slight loss of liquid due to filling material dripping from the filling head, frothing filling material when filling carbonated beverages, or defective or bursting containers. In order to keep such liquid away from other components of the apparatus, it is advantageous to assemble the components for the filling, prior to the closing of the containers, in a so-called wet area, which is isolated from the other components by suitable measures, such as air locks, for example, curtains of air etc.

With the arrangement according to the invention with linear transfer line, very compact layouts can be built and in particular a very compact wet area can be realized.

Optionally, the transfer device may have a drying device, by which any filled containers which have gotten wet on account of filling material spray can be dried before entering the process wheel for the closing. In this way, the load on the components of the process wheel for the closing as well as all ensuing components due to liquid can be effectively reduced.

The transfer device may advantageously have an inspection device, especially in order to check the fill level of filled containers.

The transfer device may have holding mechanisms for the containers, which are movable at variable speed along the transfer line. In particular, the holding mechanisms may be driven along the transfer line by a worm drive with variable pitch and/or by a magnetic drive. In this way, the distances between adjacent containers between the two process wheels can be changed and adapted to a different spacing distance of the process wheels. For example, the process wheel for the closing may have a smaller radius or be outfitted more closely with processing stations than the process wheel for the filling of a container, especially in the case of a combined forming and filling wheel, in which the container is simultaneously formed and filled inside a mold. The spacing distances may then be adapted along the transfer line. The space requirement of a machine can be optimized.

The filled containers are usually held by grippers in the area of the mouth. Along the transfer line it may be advantageous to support and/or guide the filled containers at least partially in the area of their bottom.

Various sample embodiments of the invention shall now be explained more closely with the aid of the enclosed figures, representing the following:

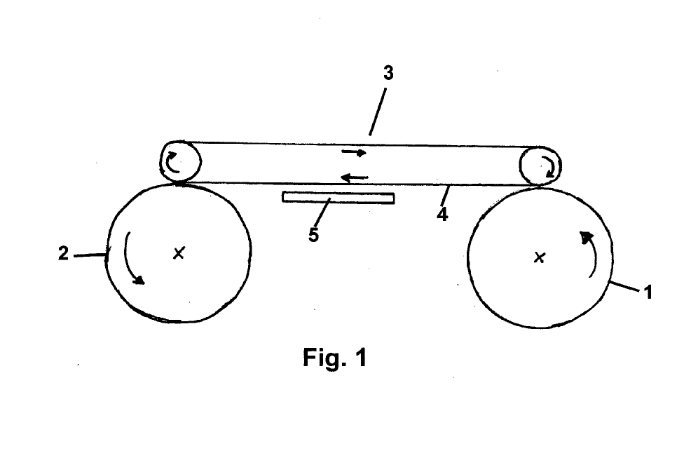

FIG. 1 shows schematically an apparatus according to the invention for the filling and closing of containers with a linear transfer line;

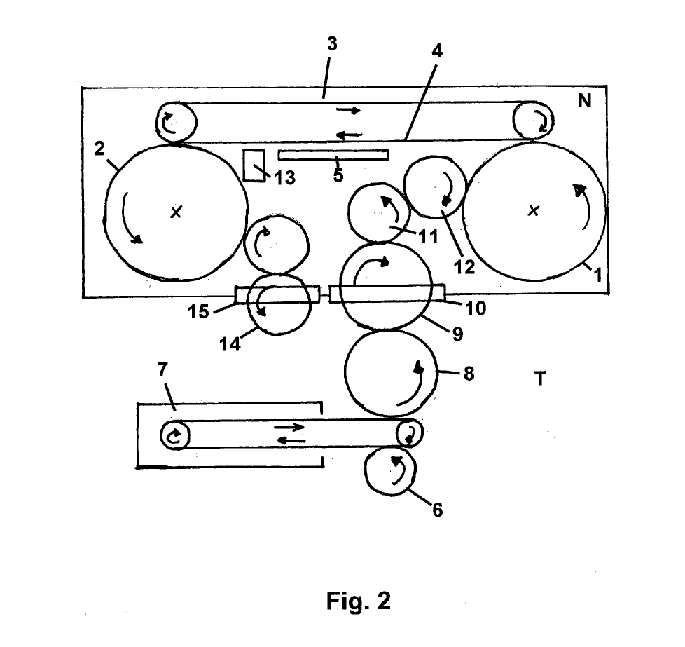

FIG. 2 shows schematically an apparatus for the production of filled containers from preforms, comprising a filling and closing apparatus according to the invention;

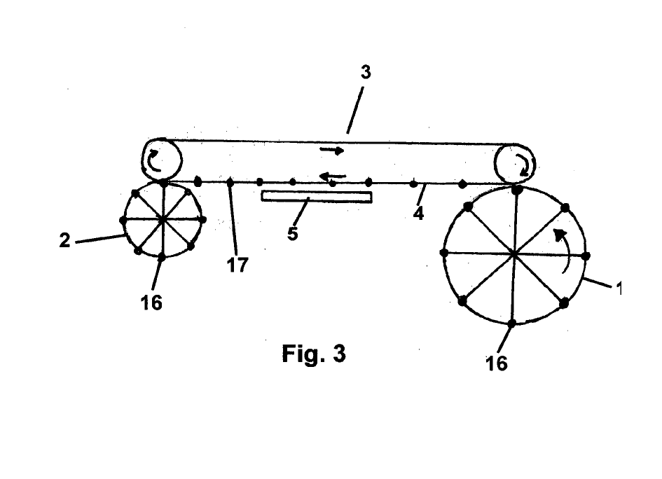

FIG. 3 shows schematically an apparatus according to the invention for the filling and closing of containers as in FIG. 1 with a linear transfer line and different division of the process wheels.

It will be obvious to the skilled person that the drawings represented here are only meant to serve as an illustration of the principle of the invention and are represented only schematically and not true to scale. In particular, the dimensions and size relations of the elements among each other only serves as an illustration. The actual dimensions and size relations may be determined by the skilled person at his discretion, based on his technical knowledge. Furthermore, only the components necessary for an understanding of the invention are represented. Actual devices may have further components.

FIG. 1 shows schematically an apparatus according to the invention for the filling and closing of containers with a linear transfer line. The apparatus comprises a first process wheel 1 for the filling of a container. On this process wheel 1 several holding positions for containers are provided, especially for bottles, which are outfitted with a filling head, so that the containers can be filled with a filling material, especially with a liquid filling material. This may be a process wheel for the filling of empty containers or a process wheel for the simultaneous forming and filling of containers from preforms, in that filling material under high pressure is introduced into appropriately processed preforms, the preform being transformed into a filled container.

The apparatus furthermore comprise a second process wheel 2 for the closing of a filled container.

Between the process wheels 1, 2 is arranged a transfer device 3 for the transfer of the filled containers from the first process wheel 1 to the second process wheel 2. The transfer device 3 according to the invention comprises a linear transfer line 4.

The transfer line 4 adjoins the first process wheel 1 tangentially, so that during the transfer no acceleration is acting on the filled container, such as would be the case, for example, during the transfer on a transfer wheel on which the filled container is moved on a counterrotating circular path.

The connection of the transfer line 4 to the second process wheel 2 likewise occurs tangentially to the circumference of the second process wheel 2. While an acceleration of the filled container occurs here due to the transfer to the circular path of the process wheel 2, the acceleration is significantly less than in the case of the transfer from a counterrotating transfer wheel.

The transfer line 4 is advantageously outfitted with a drying device 5, such as a blower, in order to remove any filling material spray from the outside of the filled containers and pass on the least possible liquid to the second process wheel of the closing mechanism.

FIG. 2 shows schematically an apparatus for the production of filled containers from preforms comprising a filling and closing apparatus according to the invention.

The apparatus comprises a process wheel 1 for the simultaneous forming and filling of a container from a preform by filling material introduced under high pressure into the preform. For this, suitable preforms are singled out on a feeding wheel 6 and supplied to a heating section 7, along which the preforms are thermally processed so as to become thermoplastically deformable.

The thermally processed preforms are then taken out of the heating section 7 by a transfer wheel 8, which produces a spacing distance in the preforms emerging from the heating section such that the spacing distance between adjacent preforms on the transfer wheel 8 during the transfer to the next transfer wheel 9 corresponds to the required spacing distance in the later transit. For this, the transfer wheel 8 has telescopic arms.

The transfer wheel 9 moves through an air lock 10 to the wet area N of the layout, in which the filling and closing of the container takes place.

In the wet area, the preforms are taken by further transfer wheels 11, 12 to the first process wheel 1, on which forming and filling stations are arranged by which the preforms in known manner are transformed into filled containers by introducing of filling material under high pressure.

After the completion of the container forming and filling, the forming and filling head is removed from the mouth of the respective container. The filled containers are transferred from the process wheel 1 to the transfer device 3, where they are transported along a linear transfer line 4.

During the transfer from the forming and filling wheel 1 to the linear transfer line 4 no accelerations occur on the container, such as would occur during the transfer to a transfer wheel. The risk of the filled but not yet closed container spilling and filling material getting sprayed in this way inside the machine is significantly reduced. In order to ensure the most smooth possible run of the containers through the transfer line 4, the containers held in the mouth region are additionally guided at the bottom, so that a pendulum motion of the container arriving from the rotary motion of the first process wheel 1 during the course of the transfer line 4 is prevented.

The linear transfer line 4 may be used to achieve an outer drying of the containers by means of the drying device 5, so as to dry any filling material spray or drip during the filling. Furthermore, an inspection device 13 may be arranged along the transfer line, with which for example the fill level inside the filled container can be checked.

The transfer of the filled container to the process wheel 2 for the closing of the container occurs tangentially to the circumference of the process wheel 2. The acceleration which occurs to bring the containers onto the circular path of the process wheel 2 is substantially less than the transfer from a counterrotating transfer wheel.

After the closing of the containers on the process wheel 2, the containers are put out from the apparatus via a transfer wheel 14 and once more move through an air lock 15, which separates the wet area N from the dry area T of the machine.

Thanks to the linear transfer line 4, the wet area of the apparatus may be especially space-saving in design. At the same time, the process wheel 1 for the filling, having the greatest likelihood of the filling material being sprayed, can be spaced further away from the process wheel for the closing of the containers, so that less liquid can get into this area. Furthermore, the distance can be utilized for the outer drying of the containers.

FIG. 3 shows an apparatus with the fundamental layout of the apparatus in FIG. 1, but the two process wheels 1, 2 have different spacing distances. The second process wheel 2 for the closing of the filled containers may be smaller in design than the first process wheel 1 for the simultaneous forming and filling of containers from preforms. On this first process wheel, a mold is required in which filling material under high pressure is supplied to a preform, the preform being transformed into a filled container. The mold requires more space than a closing mechanism on the second process wheel 2, so that the diameter of the first process wheel 1 must be chosen large enough. The processing stations 16 on the process wheels 1, 2 therefore have different spacings.

At the transfer device 3 there are arranged holder devices 17 for the filled containers, which move at variable speed along the transfer line 4, so that the spacings are variable. The spacings can in this way be decreased between the transfer from the process wheel 1 to the transfer to the process wheel 2. The apparatus may have a space-saving design thanks to the smaller chosen process wheel 2.

The movement of the holding devices 17 along the transfer line 4 at variable speed can be done with a worm drive with variable pitch and/or with a magnetic drive.

1. An apparatus for filling and closing containers comprising:
a first process wheel for filling a container;
a second process wheel for closing a filled containers; and
a transfer device for transferring filled containers from the first process wheel to the second process wheel;
wherein the transfer device has a linear transfer line.

2. The apparatus according to claim 1, wherein the first process wheel is a process wheel configured for the simultaneous forming and filling of a container made from a preform by introducing filling material into the preform under high pressure.

3. The apparatus according to claim 1, wherein the linear transfer line is arranged tangentially to a circumference of the first process wheel or to a circumference of the second process wheel.

4. The apparatus according to claim 1, wherein the first process wheel, the second process wheel and the transfer device are arranged inside a wet area that closes off the first process wheel, the second process wheel and the transfer device from other components of the apparatus.

5. The apparatus according to claim 4, wherein the wet area is closed off from a dry area by air locks.

6. The apparatus according to claim 1, wherein the transfer device includes a drying device.

7. The apparatus according to claim 1, wherein the transfer device includes an inspection device for inspecting a fill level of filled containers.

8. The apparatus according to claim 1, wherein the transfer device includes holding devices for holding the containers, and wherein said holding devices are movable at variable speeds along the transfer line.

9. The apparatus according to claim 1, wherein the holding devices are driven along the transfer line by a worm drive with variable pitch or by a magnetic drive.

10. The apparatus according to claim 1, wherein filled containers are supported or guided along the transfer line at least partially in an area of a bottom of the filled containers.

11. The apparatus according to claim 3, wherein the linear transfer line is arranged tangentially to the circumference of the first process wheel and to the circumference of the second process wheel.

12. The apparatus according to claim 8, wherein the holding devices are driven along the transfer line by the worm drive with variable pitch and by the magnetic drive.

13. The apparatus according to claim 10, wherein filled containers are supported and guided along the transfer line at least partially in the area of the bottom of the filled containers.
